(19) United States
(12) Patent Application Publication
(10) Pub. No.: US 2013/0063431 A1
(43) Pub. Date: Mar. 14, 2013

(54) THREE DIMENSIONAL (3D) IMAGE DISPLAY APPARATUS AND METHOD THEREOF

(71) Applicant: Sang-moo PARK, Yongin-si (KR)

(72) Inventor: Sang-moo PARK, Yongin-si (KR)

(73) Assignee: SAMSUNG ELECTRONICS CO., LTD., Suwon-si (KR)

(21) Appl. No.: 13/608,779

(22) Filed: Sep. 10, 2012

Related U.S. Application Data
(60) Provisional application No. 61/532,343, filed on Sep. 8, 2011.

(30) Foreign Application Priority Data
Aug. 8, 2012 (KR) 10-2012-0086710

(51) Int. Cl. G06T 15/00

(52) U.S. Cl. 345/419

(57) ABSTRACT

A three dimensional (3D) image display apparatus is provided, which includes a display which outputs a 3D image, a barrier which opens a first area to pass a light in a first direction of a 3D image pixel constituting the 3D image, and which closes a second area to block a light in a second direction of the 3D image pixel, and a controller which controls an operation of the barrier so that the first area becomes narrower than the second area.

### CROSS-REFERENCE TO RELATED APPLICATIONS

This application claims priority from U.S. Provisional Application No. 61/532,343, filed on Sep. 8, 2011, in the United States Patent and Trademark Office, Korean Patent Application No. 10-2012-0086710 filed on Aug. 8, 2012, in the Korean Intellectual Property Office, the disclosures of which are incorporated herein by reference in their entirety.

### BACKGROUND

1. Field

Apparatuses and methods consistent with exemplary embodiments relate to displaying three dimensional (3D) images, and more particularly, to a 3D image display apparatus and a method thereof which improve a visual field of display.

2. Description of the Related Art

Many different types of electronic apparatuses have been developed and distributed according to the advancement of electronic technology. A display apparatus such as a television is one example of an electronic apparatus.

The three dimensional (3D) display apparatus providing a 3D image screen has recently been developed. The 3D display apparatus is mainly categorized into a glasses type and a non-glasses type, depending on use or non-use of the glasses for 3D viewing.

One example of the glasses system includes a shutter glass display apparatus. The ‘shutter glasses’ display method refers to alternately outputting left-eye images and right-eye images, while alternately tuning on and off left and right shutter glasses in association with the alternate output of the left-eye and right-eye images, thereby giving a viewer an illusion of depth.

The non-glasses system is also called an auto-stereoscopic system. The non-glasses type 3D display apparatus displays spatially-shifted multi-view images, and transmit lights corresponding to different image views to the left and right eyes of the viewer using parallax barrier technology or a lenticular lens, thereby giving the user an illusion of depth. Accordingly, the non-glasses system has the advantage that the viewer can view a 3D image without having to wear glasses.

FIG. 1 is a view provided to explain a principle of a conventional display using a parallax barrier.

Referring to FIG. 1, a barrier 10 is arranged on one side of a display panel 20. The barrier 10 has a plurality of perpendicular line patterns. The even-numbered lines (a) and odd-numbered lines (b) are driven alternately to be turned on or off.

The display panel 20 displays frames in which left-eye and right-eye images (L, R) are alternately arranged in a direction of horizontal rows, and then displays frames in which positions of the left-eye and right-eye images are opposite to each other.

The barrier 10 switches driving of the odd-numbered and even-numbered lines in accordance with the operation of the display panel 20. Accordingly, the viewer sees depth as left-eye image is consistently introduced into the left eye of the viewer, while right-eye image is also consistently introduced into the right eye of the viewer.

As explained above, in a parallax barrier type display apparatus which outputs multi-view images, an area (‘visual field’) for viewing the multi-view image is limited. The degree of a user's movement allowed within the visual field is called a ‘degree of freedom.’ The viewer may not be able to watch the image conveniently if the degree of freedom is low. Accordingly, a method is necessary, which can improve the degree of freedom. That is, a technology to expand the visual field of the viewer of the non-glasses system is necessary.

### SUMMARY

Exemplary embodiments of the present inventive concept overcome the above disadvantages and other disadvantages not described above. Also, the present inventive concept is not required to overcome the disadvantages described above, and an exemplary embodiment of the present inventive concept may not overcome any of the problems described above.

According to an exemplary embodiment, a three dimensional (3D) image display apparatus and a method thereof which ensure wider visual field are provided.

In an aspect of an exemplary embodiment, a three dimensional (3D) image display apparatus is provided, which may include a display which outputs a 3D image, a barrier which opens a first area to pass a light in a first direction of a 3D image pixel constituting the 3D image, and which closes a second area to block a light in a second direction of the 3D image pixel, and a controller which controls an operation of the barrier so that the first area becomes narrower than the second area.

The barrier may include a first electrode which applies voltage to the first area, and a second electrode which applies voltage to an area that is the same size as the first area. The controller may control the first and second electrodes so that they operate at alternating times.

The first and second electrodes may construct an upper electrode of the barrier, and the barrier may additionally include a lower electrode which applies default voltage to the first and second areas.

The barrier may include a first electrode which applies voltage to the first area, a second electrode which applies voltage to a third area which is part of the second area and which is in the same size as the first area, and a third electrode which applies voltage to a fourth area which is part of the second area excluding the third area. The controller controls the first and second electrodes to operate at alternating times in which the third electrode does not apply voltage.

The first, second and third electrodes construct an upper electrode of the barrier, and the barrier additionally comprises a lower electrode which applies default voltage to the first area, the third area, and the fourth area.

The 3D image display apparatus may additionally include a backlight which supplies a light source to the 3D image display apparatus, wherein the controller may control the first area to be open and the second area to be closed only when the light source is supplied through the backlight.

The 3D image may include a first frame in which left-eye and right-eye image pixels are alternately arranged in a horizontal direction, and a second frame in which the left-eye and right-eye image pixels are alternately arranged in a horizontal direction, and the controller may switch the operation of the barrier at a display timing of the first and second frames.

The 3D image display apparatus may additionally include a frame processor which constructs the first and second frames by combining a plurality of sub-pixels constituting the left-eye image pixel and a plurality of sub-pixels constituting the right-eye image pixel.

The frame processing unit may construct the first and second frames by selecting sub-pixels from among Red (R), Green (G), Blue (B) sub-pixels constituting the left-eye image pixel and red (r), green (g), blue (b) sub-pixels constituting the right-eye image pixel to be arranged in the first and second frames by combining the selected sub-pixels into new pixels.

According to an exemplary embodiment, a method for displaying three dimensional (3D) image may include outputting a 3D image, and operating a barrier to open a first area to pass a light in a first direction of a 3D image pixel, and close a second area to block a light in a second direction of the 3D image pixel. The operating the barrier may include operating the barrier so that the first area becomes narrower than the second area.

The method may additionally include operating the barrier so that the first and second areas open at alternating times.

The operating the barrier may include opening the first area and closing the second area only when a backlight light source is supplied.

The second area may include a third area that is the same size as the first area, and a fourth area other than the third area, wherein the method may additionally include operating the barrier so that the first and third areas open at alternating times and closing the fourth area.

The 3D image may include a first frame in which left-eye and right-eye image pixels are alternately arranged in a horizontal direction, and a second frame in which the left-eye and right-eye image pixels are alternately arranged in a horizontal direction.

The method may additionally include frame processing by constructing the first and second frames by combining a plurality of sub-pixels constituting the left-eye image pixel and a plurality of sub-pixels constituting the right-eye image pixel.

The frame processing may include constructing the first and second frames by selecting sub-pixels from among Red (R), Green (G), and Blue (B) sub-pixels constituting the left-eye image pixel and red (r), green (g), blue (b) sub-pixel constituting the right-eye image pixel to be arranged in the first and second frames and by combining the selected sub-pixels into new pixels.

According to an aspect of an exemplary embodiment, a wider visual field may be achieved in non-glasses type 3D image display.

### BRIEF DESCRIPTION OF THE DRAWINGS

The above and/or other aspects of the present inventive concept will be more apparent by describing exemplary embodiments of the present inventive concept with reference to the accompanying drawings, in which:

FIG. 1 is a view provided to explain a principle of a conventional display apparatus using a parallax barrier;

FIG. 2 is a view illustrating a constitution of a barrier unit and a display unit for blocking or passing image pixel units;

FIG. 3 is a view illustrating a constitution of a barrier unit and a display unit for blocking or passing sub-pixel units;

FIG. 4 is a view illustrating a constitution of a barrier unit and a display unit for blocking or passing two sub-pixel units;

FIG. 5 is a view provided to explain operation of a barrier unit and a display unit for resolution compensation;

FIGS. 6 to 8 are views provided to explain operation of a barrier unit according to FIGS. 2 to 4;

FIG. 9 is a block diagram of a three dimensional (3D) image display apparatus which can expand a visual field according to an exemplary embodiment according to an aspect of an exemplary embodiment;

FIGS. 10 to 12 are views illustrating operation of a barrier unit to cause open area to be narrower than closed area according to aspects of various exemplary embodiments;

FIG. 13 is a block diagram of a 3D display apparatus including electrodes according to an aspect of an exemplary embodiment;

FIG. 14 is a block diagram of a 3D image display apparatus according to an aspect of an exemplary embodiment;

FIG. 15 is a view illustrating electrode structure of a 3D image display apparatus according to an aspect of an exemplary embodiment;

FIG. 16 is a view illustrating a controlling situation of a barrier unit at an electrode structure of a 3D image display apparatus;

FIG. 17 is a view illustrating controlling of the operation of a barrier unit within a predetermined section of an image display timing according to an aspect of an exemplary embodiment;

FIG. 18 is a view illustrating controlling of the operation of a barrier unit within a predetermined section of an image display timing according to another aspect of an exemplary embodiment;

FIG. 19 is a view illustrating an electrode structure of a 3D image display apparatus according to another aspect of an exemplary embodiment;

FIGS. 20 to 22 are views illustrating controlling situation of a barrier unit at the electrode structure of FIG. 19;

FIG. 23 is a view illustrating a pixel structure when an output image is constructed in a manner explained above, and

FIGS. 24 to 27 are flowcharts provided to explain a 3D image display method according to aspects of various exemplary embodiments.

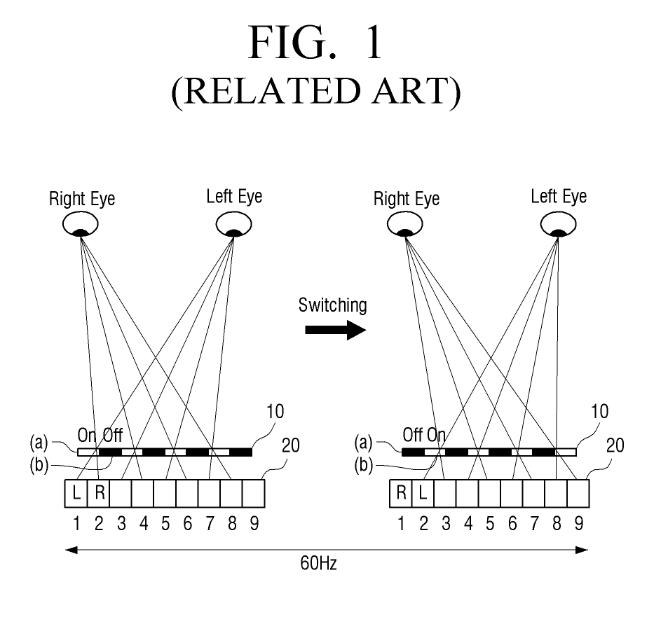

### DETAILED DESCRIPTION OF EXEMPLARY EMBODIMENTS

Certain exemplary embodiments of the present inventive concept will now be described in greater detail with reference to the accompanying drawings.

In the following description, same drawing reference numerals are used for the same elements even in different drawings. The matters defined in the description, such as detailed construction and elements, are provided to assist in a comprehensive understanding of the present inventive concept. Accordingly, it is apparent that the exemplary embodiments of the present inventive concept can be carried out without those specifically defined matters. Also, well-known functions or constructions are not described in detail since they would obscure the exemplary embodiments with unnecessary detail.

Barrier types according to various examples will first be explained below.

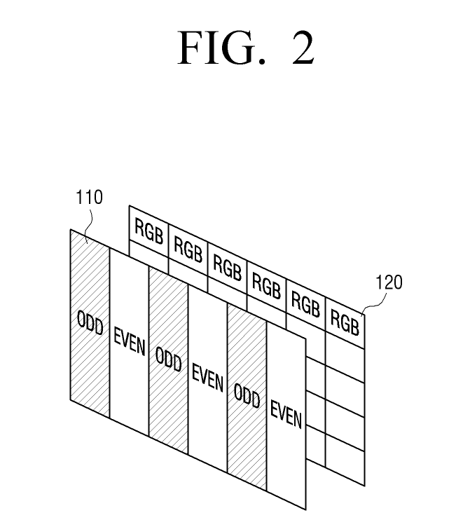

FIGS. 2 to 4 are views provided to explain a barrier type according to various embodiments.

The barrier is an element employed to pass a multi-view image in a predetermined direction and block a multi-view view image in the other directions. To be specific, among the light projected to the pixels of the 3D image, the barrier may pass the light in the direction where the viewer can view with his or her left eye, while blocking the light in a direction where the viewer can view with his or her right eye. Conversely, the barrier may pass the light in the direction where the viewer can view with his or her right eye, while blocking the light in a direction where the viewer can view with his or her left eye. As a result, the viewer may view one pixel with his or her left or right eye only.

The operation of the barrier may be performed in pixel-wise unit which constructs the image, or performed in a sub-pixel-wise unit which constructs one pixel.

FIG. 2 illustrates the constitution of a barrier unit 110 (e.g., a barrier) which blocks or passes the image in pixel-wise unit, and a display unit 120 (e.g., a display). In an embodiment explained below, the barrier unit 110 may perform the same operation as explained above.

Referring to FIG. 2, one pixel consists of Red (R), Green (G), Blue (B) sub-pixels, and the barrier unit 110 passes or blocks lights in a certain direction of the respective pixels. Since the block area and pass area can be numbered in order by 1, 2, 3, and so on, the respective areas may be marked as ODD, EVEN, ODD, EVEN for convenience of explanation. Referring to FIG. 2, ODD area is closed, while EVEN area is open. The light of the pixel passes through the open EVEN area, while the light of the pixel is blocked at the closed ODD area. By way of example, a certain pixel constituting the left-eye image is passed through the EVEN area of the barrier unit 110 which passes only the light in the left-eye direction, while the light in the right-eye direction is blocked by the ODD area and does not arrive at the right eye. Conversely, a certain pixel constituting a right-eye image may be passed through the EVEN area of the barrier unit 110 which passes only the light in the right-eye direction, while the light in the left-eye direction is blocked by the ODD area and does not arrive at the left eye.

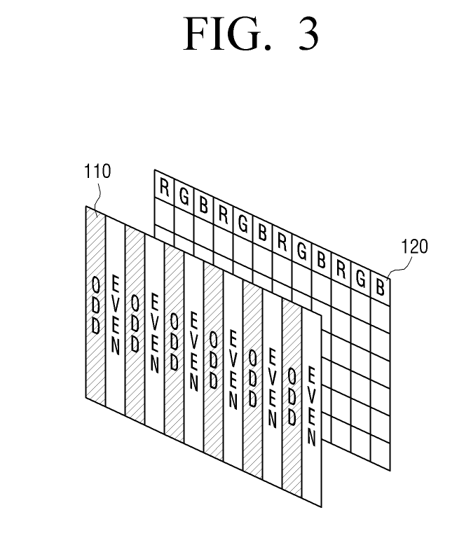

FIG. 3 illustrates a constitution of the barrier unit 110 which blocks or passes the light of sub-pixel units, and a display unit 120.

Referring to FIG. 3, light may be passed or blocked in each of the sub-pixels R, G, B constituting one pixel. As explained above with reference to the example, the area ODD is closed, the area EVEN is open, so that the light of the pixel passes through the area EVEN which is open, and is blocked at the area ODD which is closed. For example, pixel G of a certain pixel constituting a left-eye image passes through the area EVEN of the barrier unit 110 which passes only the light in the left-eye direction, while the light in the right-eye direction is blocked at the area ODD and does not arrive at the right eye. On the contrary, pixel R of a certain pixel constituting a right-eye image passes through the area EVEN of the barrier unit 110 which passes only the light in the right-eye direction, while the light in the left-eye direction is blocked at the area ODD and does not arrive at the left eye.

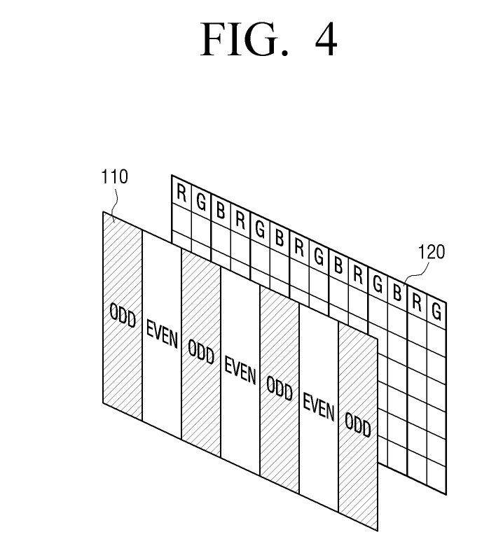

FIG. 4 is a view illustrating a constitution of a barrier unit and a display unit for blocking or passing two sub-pixel units.

Referring to FIG. 4, light may be allowed to pass or be blocked in the unit of two sub-pixels with respect to the respective sub-pixels R, G, B constituting one pixel.

As explained above with reference to the example, the area ODD is closed, and area EVEN is open, so that the light of the two sub-pixels pass the area EVEN which is open, while the light of the two sub-pixels is blocked at the area ODD which is closed. For example, pixels R, G of a certain pixel constituting a left-eye image pass through the area EVEN of the barrier unit 110 which passes only the light in the left-eye direction, while the light in the right-eye direction is blocked at the area ODD and does not arrive at the right eye. On the contrary, pixels R, B of a certain pixel constituting a right-eye image passes through the area EVEN of the barrier unit 110 which pass only the light in the right-eye direction, while the light in the left-eye direction is blocked at the area ODD and does not arrive at the left eye.

As explained above, the barrier unit 110 may either pass or block light in the left-eye direction or right-eye direction. Meanwhile, when one multi-view frame is constructed with a combination of left-eye and right-eye image frames of a 3D image, the entire horizontal rows cannot be displayed on one frame. That is, due to a limit in the size of one frame, the horizontal rows corresponding to half of the left-eye image frame and half of the right-eye image frame may only be combined. Accordingly, resolution degrades from the original image, and a method is necessary, which can compensate for the degraded resolution.

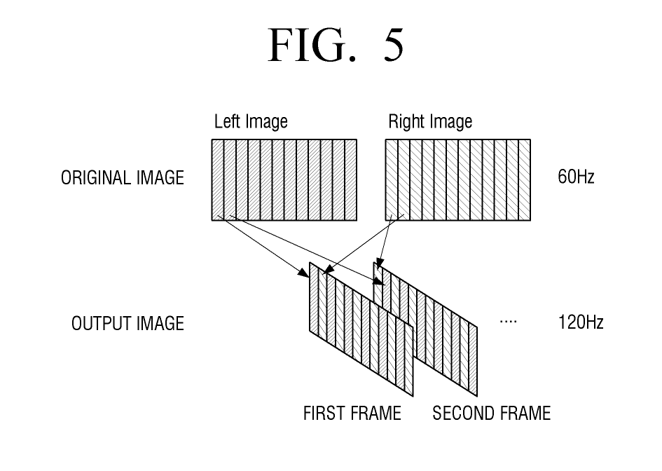

FIG. 5 is a view provided to explain operation of the barrier unit 110 and the display unit 120 for compensation of the resolution.

Referring to FIG. 5, the 3D image display apparatus 100 according to an embodiment receives left-eye and right-eye image frames contained in the original image. The frame processing unit (not illustrated) of the 3D image display apparatus 100 divides the left-eye and right-eye image frames into a plurality of horizontal rows, and combines the odd-numbered lines of the left-eye image frame with the odd-numbered lines of the right-eye image frame to construct odd frame, and also combines the even-numbered lines of the right-eye image frame with the even-numbered lines of the left-eye image frame to construct even frame, respectively. Hereinbelow, the odd frame will be referred to as the first frame, while the even frame is referred to as the second frame. The first and second frames are output image.

With the increase of image frame rate, the first and second frames are outputted. By way of example, if the image frame rate is 60 Hz, the display unit 120 may display the first and second frames at 120 Hz. Accordingly, the resolution is maintained.

The odd frame constructs an image frame in the order of odd-numbered line 1 of the right image, odd-numbered line 1 of the left-eye image frame, odd-numbered line 2 of the right-eye image frame, odd-numbered line 2 of the left-eye image frame, and so on. The even frame constructs an image frame in the (reverse) order, which is, even-numbered line 1 of the right image, even-numbered line 1 of the right-eye image frame, even-numbered line 2 of the left-eye image frame, even-numbered line 2 of the right-eye image frame, and so on. The opening/closing of the areas ODD, EVEN of the barrier unit 110 are switched in accordance with switching of the first and second frames which will be explained below.

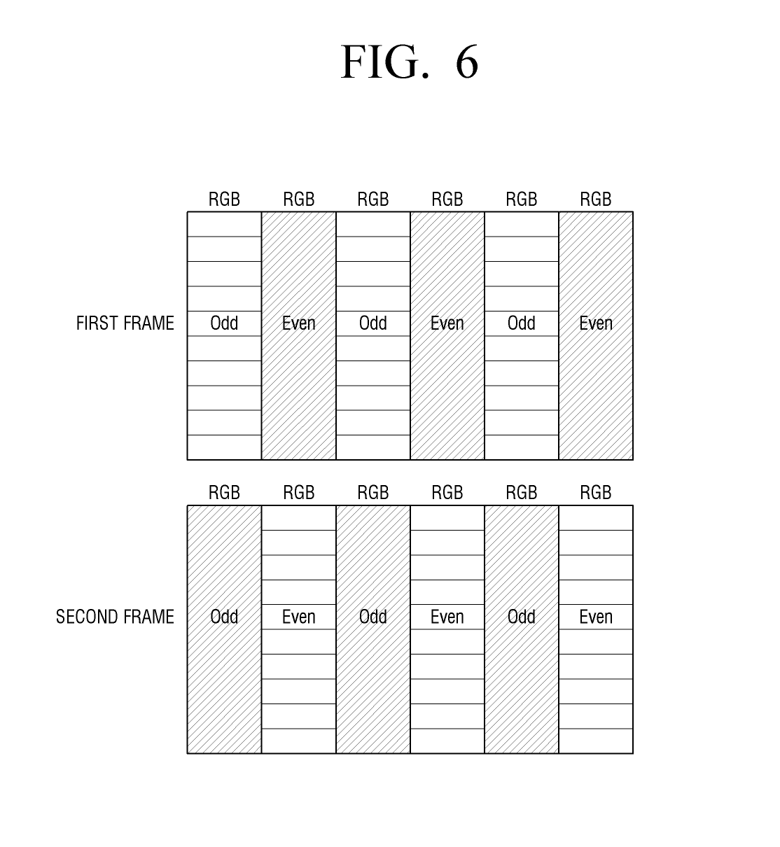

FIGS. 6 to 8 are views provided to explain operation of the barrier unit 110 of FIGS. 2 to 4.

Referring first to FIG. 6, like FIG. 2, one pixel consists of R, G, B sub-pixels and the barrier unit 110 passes or blocks light of the pixels in a certain direction. Since the areas to pass or block the light can be numbered as 1, 2, 3, and so on, for convenience of explanation, these areas are indicated as ODD, EVEN, ODD, EVEN, or the like. As illustrated, area ODD is closed, and area EVEN is open. The light of the pixel passes through the area EVEN which is open, while the light of the pixel is blocked at the area ODD which is closed. Different from FIG. 2, the opening and closing of the areas ODD and EVEN are switched in accordance with the switching of the first and second frames. That is, area ODD may be open and the area EVEN may be closed in the first frame, and as the second frame is displayed, the area ODD may then be closed while the area EVEN is open.

By way of example, if the first frame is displayed, a certain pixel constituting a left-eye image may pass through the area ODD of the barrier unit 110 that passes only the light in the left-eye direction to arrive at the left eye, while the light in the right-eye direction is blocked at the area EVEN and does not arrive at the right eye. In contrast to the area EVEN, a certain pixel constituting a right-eye image may pass through the area ODD of the barrier unit 110 that passes only the light in the right-eye direction to arrive at the right eye, while the light in the left-eye direction is blocked at the area EVEN and does not arrive at the left eye. However, as the second frame is displayed, the operation of the barrier unit 110 may be switched. The second frame has the pixels constituting the left-eye and right-eye images in the order opposite to that of the first frame. Accordingly, as the second frame is displayed, a certain pixel constituting a right-eye image may pass through the area EVEN of the barrier unit 110 that passes only the light in the right-eye direction to arrive at the right eye, while the light in the left-eye direction is blocked at the area ODD and does not arrive at the left eye. In addition, a certain pixel constituting a left-eye image may pass through the area EVEN of the barrier unit 110 that passes only the light in the left-eye direction to arrive at the left eye, while the light in the right-eye direction is blocked at the area ODD and does not arrive at the right eye.

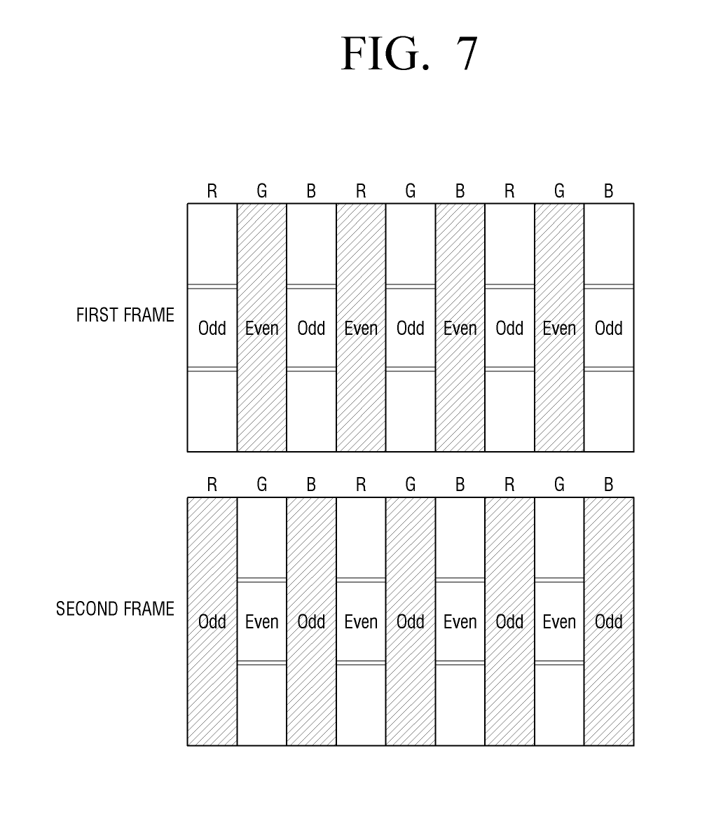

Referring to FIG. 7, like FIG. 3, light may be passed or blocked in each of the sub-pixels R, G, B constituting one pixel. If area ODD is closed, and EVEN is open, the light of the pixel passes through the area EVEN which is open and blocked at the area ODD which is closed. In contrast to FIG. 3, the opening and closing of the areas ODD and EVEN is switched in accordance with switching of the first and second frames. That is, if the area ODD is open and area EVEN is closed in the first frame, as the second frame is displayed, the area ODD may be closed and the area EVEN may be open.

For example, in a state that the first frame is displayed, pixel R of a certain pixel constituting a left-eye image passes through the area ODD of the barrier unit 110 which passes only the light in the left-eye direction, while the light in the right-eye direction is blocked at the area EVEN and does not arrive at the right eye. On the contrary, pixel R of a certain pixel constituting a right-eye image passes through the area ODD of the barrier unit 110 which passes only the light in the right-eye direction, while the light in the left-eye direction is blocked at the area EVEN and does not arrive at the left eye.

However, as the second frame is displayed, the operation of the barrier unit 110 is switched. The second frame may be constructed to include a sub-pixel of the pixel of the left-eye image, which is not included in the first frame. As explained above, if the first frame includes pixel R of a certain pixel constituting the left-eye image, the second frame may then include the rest pixels G, B of the certain pixel. Accordingly, when the second frame is displayed, pixels G, B of the certain pixel constituting a left-eye image pass through the area EVEN of the barrier unit 110 which passes only the light in the left-eye direction, while the light in the right-eye direction is blocked at the area ODD and does not arrive at the right eye. Similarly, pixels G, B of the certain pixel constituting the right-eye image pass through the area EVEN of the barrier unit 110 which passes only the light in the right-eye direction, while the light in the left-eye direction is blocked at the area ODD and does not arrive at the left eye.

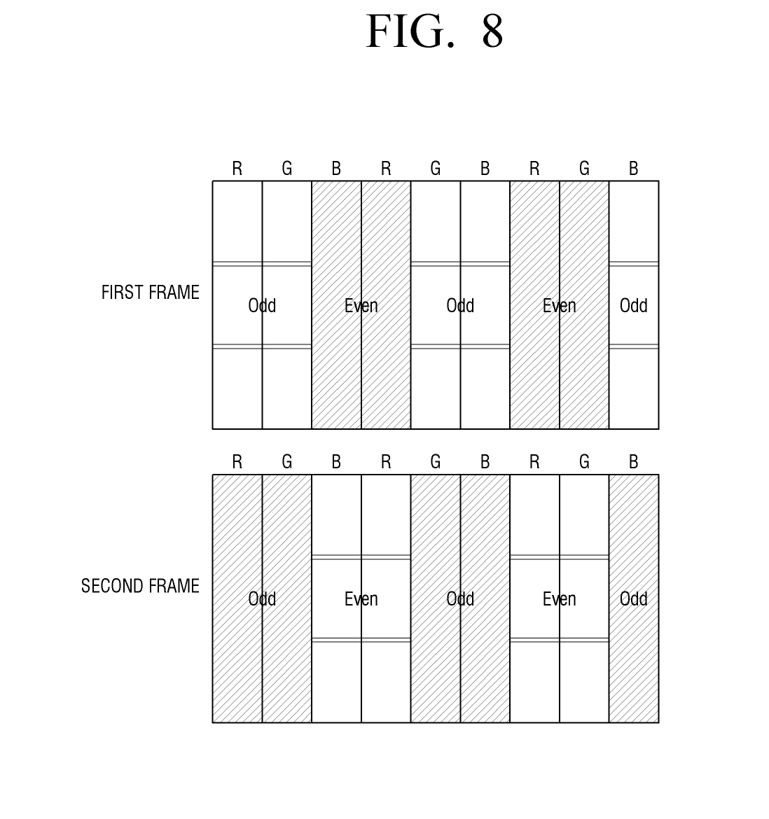

Referring to FIG. 8, like FIG. 4, light may be allowed to pass or be blocked in the unit of two sub-pixels with respect to the respective sub-pixels R, G, B constituting one pixel. As illustrated in FIG. 8, the area ODD is open, and area EVEN is closed at the timing of displaying the first frame, so that the light of the two sub-pixels pass the area ODD which is open, while the light of the two sub-pixels is blocked at the area EVEN which is closed.

For example, pixels R, G of a certain pixel constituting a left-eye image pass through the area ODD of the barrier unit 110 which passes only the light in the left-eye direction, while the light in the right-eye direction is blocked at the area EVEN and does not arrive at the right eye. On the contrary, pixels G, B of a certain pixel constituting a right-eye image passes through the area EVEN of the barrier unit 110 which pass only the light in the right-eye direction, while the light in the left-eye direction is blocked at the area ODD and does not arrive at the left eye.

However, the operation of the barrier unit 110 may be switched when the second frame is displayed. The second frame may be constructed to include the sub-pixel of the pixel constituting a left-eye image which is not included in the first frame. In the embodiment explained above, the second frame includes pixel B of a certain pixel constituting a left-eye image, and the light of the pixel B in the light-eye direction is passed through the area EVEN of the barrier unit 110 which passes only the light in the left-eye direction of the pixel B and thus arrives at the left eye, while the light in the right-eye direction is blocked at the area ODD and does not arrive at the right eye. In addition, the second frame may include pixel R of the pixel constituting the right-eye image, and the light in the right-eye direction of the pixel R is passed through the area EVEN of the barrier unit 110 which passes only the light in the right-eye direction of the pixel R, while the light in the left-eye direction is blocked at the area ODD and does not arrive at the left eye.

As explained above, since the barrier unit 110 is switched to operate the areas ODD and EVEN to be opened and closed opposite to each other, the image frame output is double-fold, and as a result, resolution compensation is made and the viewer of the 3D image display apparatus can be provided with a full image.

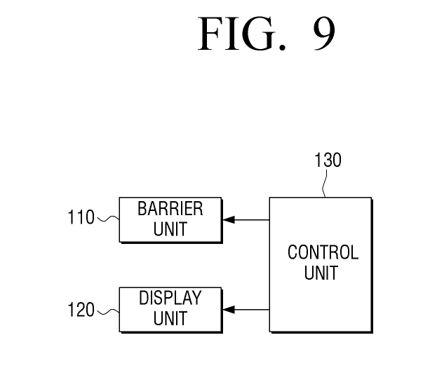

Meanwhile, the transmission of the light varies depending on the relative areas of the areas ODD and EVEN, i.e., depending on the relative areas of the opened and closed areas, and the degree of freedom also varies. Specifically, if the opened and closed areas are in 5:5 as illustrated in FIG. 9, the degree of freedom decreases and the visual field is narrowed. Accordingly, a method is necessary, which can increase the visual field.

FIG. 9 is a block diagram of a three dimensional (3D) image display apparatus which can expand a visual field according to an exemplary embodiment.

Referring to FIG. 9, the 3D image display apparatus according to an embodiment may include a display unit 120 which outputs 3D image, a barrier unit 110, the display unit 120 and a control unit 130 (e.g., a controller, processor, or circuitry which controls the barrier unit) which controls the operation of the barrier unit 110.

In various embodiments, the 3D image display apparatus 100 may be a device having display unit therein, such as, among others, TV, mobile phone, PDA, laptop computer, monitor, tablet PC, electronic book, electronic frame, kiosk, flexible display, head mounted display (HMD), or the like.

The display unit 120 may output a 3D image and, as explained above, may process the 3D original image into first and second frames, and increase a frame rate to output the first and second frames sequentially. As explained above, the locations of the left-eye and right-eye image pixels in the first and second frames may change, and the barrier unit 110 may switch the opened and closed areas accordingly.

The display unit may be implemented with a variety of display technologies such as liquid crystal display panel (LCD), plasma display panel (PDP), vacuum fluorescent display (VFD), field emission display (FED), electroluminescence display (ELD), or organic light emitting diode (OLED). Further, the display unit may be implemented as a flexible display or transparent display.

The barrier unit 110 may open the first area to pass the light in the first direction of the 3D image pixel constituting the 3D image, and close the second area to block the light in the second direction of the 3D image pixel. The first direction may be the left-eye image direction, and the second direction may be the right-eye image direction, or vice versa. Further, the first area may be area ODD and the second area may be area EVEN, or vice versa.

The control unit 130 may control the operation of the display unit 120 and the barrier unit 110. To be specific, the control unit 130 may control the operation of the barrier unit 120 to cause the first area to be narrower than the second area. If the degree of opening of the barrier unit 110 for compensating resolution is set to about 5:5, the area that can provide the viewer with the feeling of depth is narrowed. According to an exemplary embodiment, such shortcoming may be prevented, because if the area opened by the barrier unit 110 is narrower than the closed area, the degree of freedom increases and the visual field increases. By way of example, the ratio of the closed area to the opened area to may be set to 7:3.

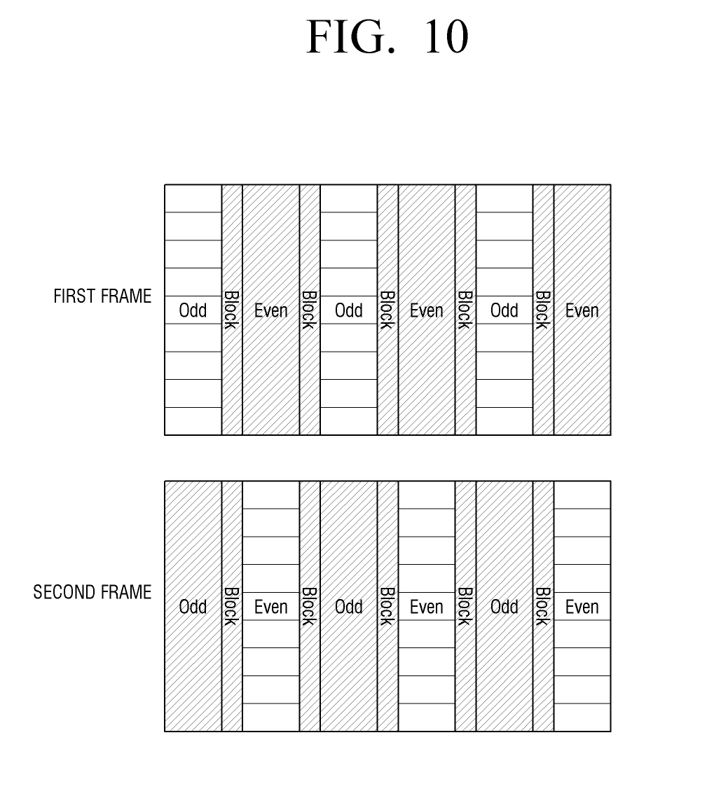

FIGS. 10 to 12 are views illustrating the operation of the barrier unit 110 to cause the open area to be narrower than the closed area.

FIG. 10 illustrates an example where the battier is operated in the same manner as illustrated in FIG. 6. Differently from FIG. 6, the closed area is wider than the open area.

The area ODD is open and the area EVEN is closed when the first frame is displayed. As explained with reference to FIG. 6, the light of the pixel passes through the area ODD which is open, while the light of the pixel is blocked at the area EVEN which is closed. Differently from FIG. 6, there are additional closed areas BLOCK on left and right sides of the area EVEN with respect to each of the areas ODD. Accordingly, there are EVEN and two BLOCK as closed areas for one open area ODD.

Similarly to FIG. 6, the opening and closing of the areas ODD and EVEN is switched according to switching of the first and second frames. If the second frame is displayed, the area ODD is closed and the area EVEN is open. That is, in a state that the area ODD is open and the area EVEN is closed for the first frame, as the second frame is displayed, the area ODD is closed and the area EVEN is open. The areas BLOCK on left and right sides of the area ODD are also closed along with the area ODD. At this time, there are one ODD and two EVEN as closed areas for one open area EVEN.

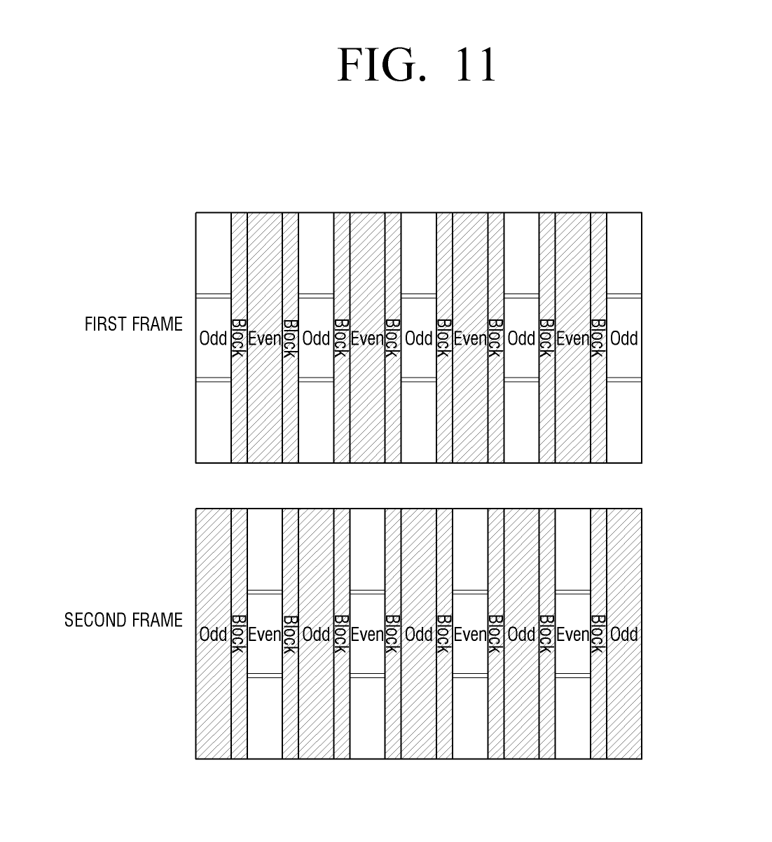

Referring to FIG. 11, similarly to FIG. 7, the barrier unit 110 may operate in the unit of a sub-pixel. However, the closed area is wider than the open area in FIG. 11.

In a state that the first frame is displayed and the area ODD is open and the area EVEN is closed, so that the light of the pixel passes through the open ODD while the light of the pixel is blocked at the closed EVEN. Differently from FIG. 7, FIG. 11 illustrates an example where there are additional closed areas BLOCK on left and right sides of EVEN. That is, referring to FIG. 11, there are one EVEN and two BLOCK as closed areas for one open ODD area.

Similarly to FIG. 7, the opening and closing of ODD and EVEN areas may be switched according to switching of the first and second frames. That is, in a state that ODD is open and EVEN is closed in the first frame, as the second frame is displayed, ODD is closed and EVEN is open. There are BLOCK areas on left and right sides of ODD which are also closed. Accordingly, there are one ODD and two EVEN (BLOCK) as closed areas for one EVEN area.

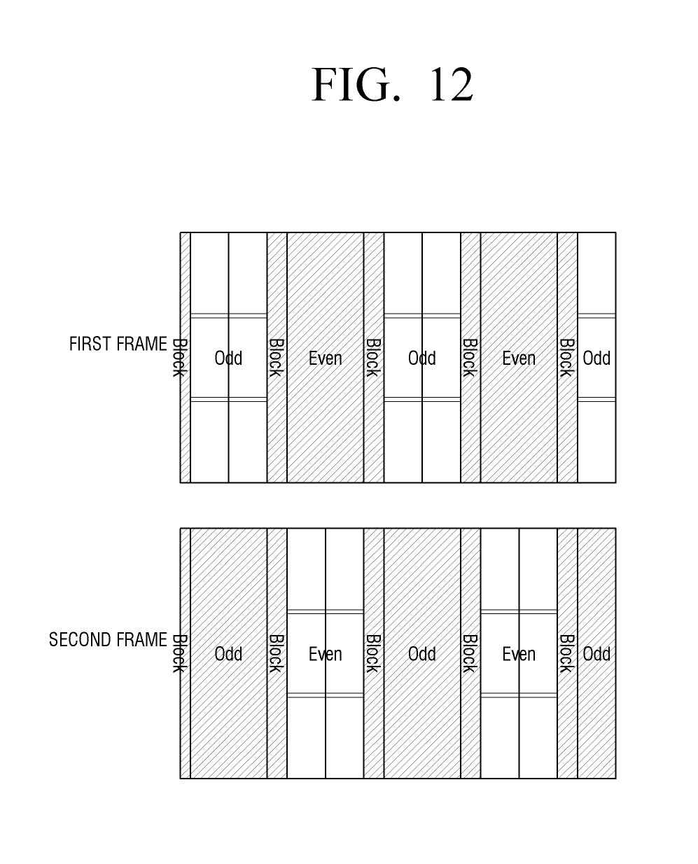

Referring to FIG. 12, as illustrated in FIG. 8, the barrier unit 110 may operate in the unit of a sub-pixel. However, the closed area is wider than the open area in FIG. 11.

In a state that the first frame is displayed and the area ODD is open and the area EVEN is closed, so that the light of the pixel passes through the open ODD area while the light of the pixel is blocked at the closed EVEN area. Differently from FIG. 8, FIG. 12 illustrates an example where there are additional closed areas BLOCK on left and right sides of EVEN. That is, referring to FIG. 12, there are one EVEN and two BLOCK areas that are closed areas for one open ODD area.

Similar to FIG. 8, the opening and closing of ODD and EVEN may be switched according to switching of the first and second frames. That is, in a state that ODD is open and EVEN is closed in the first frame, as the second frame is displayed, ODD may be closed and EVEN may be open. There are BLOCK areas on left and right sides of the ODD area which are also closed. Accordingly, there are one EVEN and two BLOCK areas that are closed areas for one open ODD area.

Also similarly to FIG. 8, light passing or blockage may be performed with respect to the respective sub-pixels R, G, B constituting one pixel in a unit of two sub-pixels. The area ODD is open and EVEN is closed at a timing of displaying the first frame. Accordingly, the light of two sub-pixels passes ODD which is open, while the light of the two sub-pixels is blocked at EVEN which is closed. This applies oppositely when the second frame is displayed.

As explained above, since the open area of the barrier unit 110 is narrower than the closed area, the visual field increases causing the degree of freedom increase.

The first and second areas (ODD, EVEN) opened or closed by the barrier unit 110 may be implemented in the form of liquid crystal cell (LCC). The LCC has an orientation which is switched according to the driving voltage, to pass or block the light depending on the switched orientation. In an aspect of an exemplary embodiment, if voltage is not applied to the LCC, the LCC blocks external light, while if the voltage is applied, the LCC may pass the external light. However, the implementation of the LCC is not limited to this specific technique.

Accordingly, the barrier unit 110 needs electrodes to provide a driving voltage to the LCC.

FIG. 13 is a block diagram of a 3D display apparatus 100 including electrodes.

Referring to FIG. 13, in a 3D display apparatus 100 according to an aspect of an exemplary embodiment, the barrier unit 110 may include a first electrode 111 which applies voltage to the first area, and a second electrode 112 which applies voltage to another area as large as the first area.

The control unit 130 may perform the switching by controlling the first and second electrodes 111, 112 to operate in a manner opposite to each other. That is, if the voltage is applied to the first electrode 111 at the timing of displaying the first frame, then the voltage is not applied to the first electrode 111 and instead applied to the second electrode 112 at a timing of displaying the second frame. Since the second electrode 112 applies voltage to the area in the same size as the first area, voltage is not applied to BLOCK anyway, and accordingly, this area blocks the light of the pixel. As a result, since the open area becomes narrower than the closed area, the effect of increased visual field is obtained.

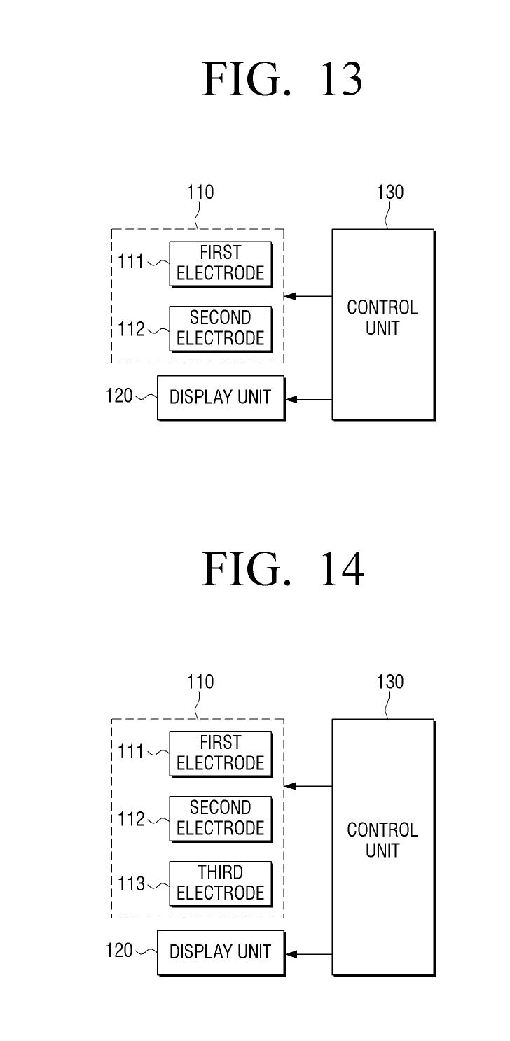

Depending on the circumstances, it may be necessary to apply the voltage to the BLOCK of the second area as well as the area in the same size as the first area. By way of example, a display apparatus for multiple uses may display a 2D image instead of a 3D image. FIG. 14 illustrates a constitution of a 3D image display apparatus for multi-use according to an exemplary embodiment.

FIG. 14 is a block diagram of a 3D image display apparatus according to various embodiments.

Referring to FIG. 14, in the 3D display apparatus 100 according to an aspect of an exemplary embodiment, the barrier unit 110 may include a first electrode 111 to apply voltage to the first area, a second electrode 112 to apply voltage to a third area (of the second area) in the same size as the first area, and a third electrode 113 to apply voltage to a fourth area (of the second area) excluding the third area.

The control unit 130 may perform the switching by controlling the electrodes so that the first and second electrodes 111, 112 operate in a manner opposite to each other. That is, if the voltage is applied to the first electrode 111 at a timing of displaying the first frame, the voltage is not applied to the first electrode 111 and instead applied to the second electrode 112 at a timing of displaying the second frame. However, the control unit 130 does not apply voltage through the third electrode. As a result, the fourth area blocks the light of the pixel. Similarly to the embodiments explained above, since the open area becomes narrower than the closed area, the effect explained above, i.e., expansion of the visual field can be obtained.

Furthermore, in order to open BLOCK, the voltage may be applied through the third electrode 113. Accordingly, use of the display apparatus for purposes other than 3D image display is enabled.

Hereinbelow, the electrode structure of the 3D image display apparatus 100 and controlling electrodes according to various embodiments will be explained.

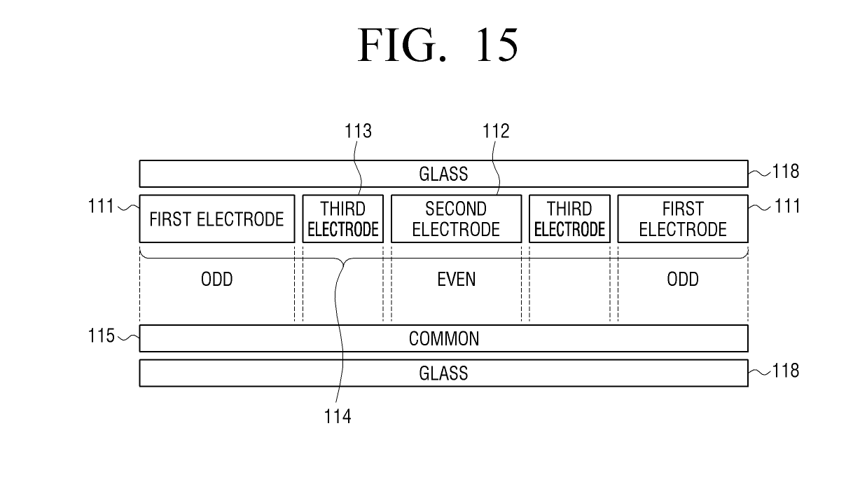

FIG. 15 illustrates the electrode structure of the 3D image display apparatus 100 according to various embodiments.

Referring to FIG. 15, the first and second electrodes 111, 112 may construct an upper electrode 114 of the barrier unit 110, and the barrier unit 110 may additionally include a lower electrode 115 to apply default voltage to the first area 111 and the second area 112. The first electrode 111 (along with the lower electrode) may open or close ODD as illustrated in FIG. 15, and the second electrode 112 may open or close EVEN. The upper and lower electrodes 114, 115 may be implemented as an indium tin oxide (ITO) transparent electrode so that the electrodes 114, 115 do not themselves block the light.

Further, a glass substrate 118 may be additionally provided on an outer surface of the upper and lower electrodes 114, 115, and liquid crystal layer may be provided between the upper and lower electrodes 114, 115.

As explained above, the orientation of the liquid crystal layer (i.e., LCC) may be switched in accordance with the driving voltage applied between the upper and lower electrodes 114, 115, and the light is either passed or blocked according to the switched orientation. In an exemplary embodiment, if voltage is not applied between the two electrodes, the LCC blocks external light, while if the voltage is applied, the external may pass.

Further, as illustrated, a third electrode 113 may be additionally provided. The third electrode 113 may open or close by applying voltage to BLOCK.

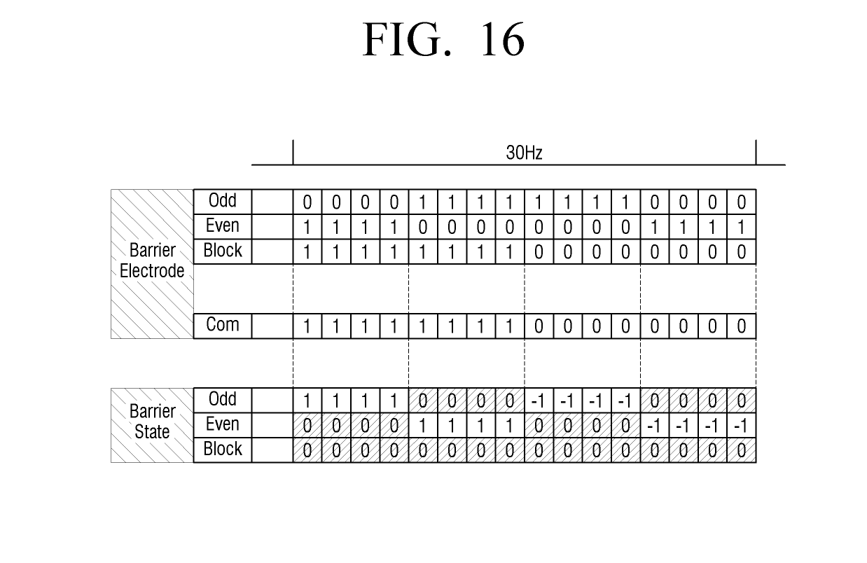

FIGS. 16 to 18 illustrate a controlling of the barrier unit 110 with the electrode structure of the 3D image display apparatus 100.

Referring to FIG. 16, the barrier unit 110 is operated under condition that the image frames are outputted for 30 Hz. Since the first and second frames are outputted at 120 Hz, respectively, 30 Hz corresponds to the duration that four frames are outputted. Accordingly, the four cells of the table correspond to duration of outputting one image frame. For convenience of explanation, it is assumed that the first, second, third and fourth frames are outputted per four cells in sequence.

When the first frame is displayed, default voltage is applied at the lower electrode 115, and the second electrode 112 applies voltage to EVEN and the third electrode 113 applies voltage to BLOCK, so EVEN and BLOCK at potential difference of 0, are in closed state. On the contrary, although the first electrode 111 does not indeed apply the voltage to ODD, due to default voltage, ODD has potential difference and thus is open. As explained above, since the open area is formed narrower than the closed area, the visual field expands.

When the second frame is displayed, the lower electrode 115 is still under default voltage, and the first electrode 111 applies voltage to ODD and the third electrode 113 applies voltage to BLOCK. Accordingly, ODD and BLOCK, which are at potential difference of 0, are in closed state. On the contrary, although the second electrode 112 does not indeed apply the voltage to EVEN, due to default voltage, EVEN has potential difference and thus is open. As explained above, since the open area is formed narrower than the closed area, the visual field expands.

When the third frame is displayed, unlike the embodiments explained above, default voltage is set as the ground voltage for the lower electrode 115. If the first electrode 111 applies voltage to ODD, and the second and third electrodes 112, 113 do not apply any voltage at all, only ODD has potential difference, so that ODD is open and the rest of the areas are closed.

The fourth frame may be displayed in the almost similar condition as displaying the third frame, but with an exception that EVEN is open.

To summarize the opening of the respective areas of the barrier unit 110 according to an exemplary embodiment, if one area is open, another area in the same size is closed, and the rest of the areas are closed. Accordingly, the closed area is wider than the open area, and through this, the visual field is expanded.

Referring to FIG. 16, it is possible to control the electrode signal for a plurality of times (four times in FIG. 16) while one image frame is displayed. Accordingly, it may be possible to control only part of the electrode signal to output image. That is, the opening and closing of the barrier unit 110 may be implemented at a timing of actually displaying 3D image.

For convenience of explanation, it is assumed that the image display apparatus 100 is equipped with a backlight unit (e.g. backlight) (not illustrated). In addition, for an emissive device such as OLED, the timing of inputting control signal corresponding to the display operation may be treated the same as the supply timing of the backlight source.

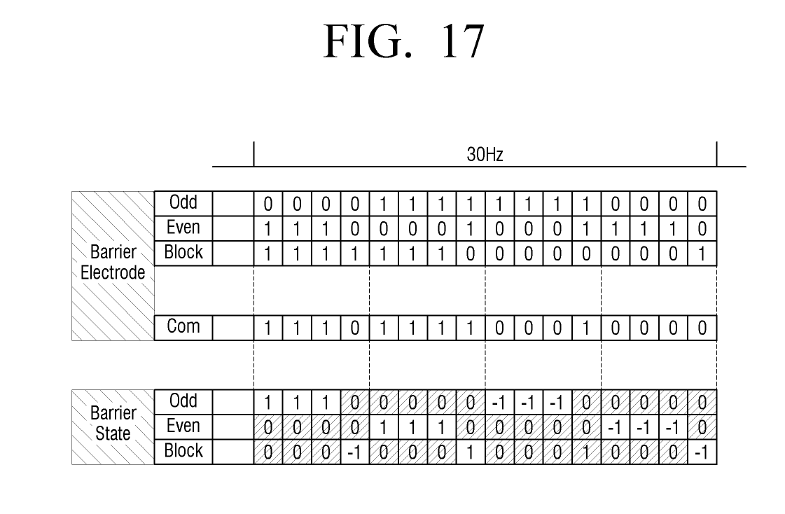

In an exemplary embodiment, the 3D image display apparatus 100 may additionally include a backlight unit (not illustrated) to supply light source. The control unit 130 may control so that the first area is open and the second area is closed only when the light source is supplied through the backlight unit (not illustrated). Referring to FIG. 17, an exemplary embodiment will be explained in greater detail.

FIG. 17 illustrates controlling the operation of the barrier unit 110 only in limited segments of the image display timing.

Referring to FIG. 17, the first to third operations of the barrier unit 110 for the duration of displaying the first frame are identical to those explained above with reference to FIG. 16. At the fourth operation, voltage is applied to BLOCK to open BLOCK. That is, for the duration of displaying the first frame, the backlight is driven only for the limited segments to output image, open ODD and close EVEN and BLOCK. However, at the fourth segment, ODD and EVEN are closed and BLOCK is open. Since image is not outputted in this segment, viewer will actually view the same 3D image as the one illustrated in FIG. 16. Controlling the image output through the backlight unit is explained for the purpose of illustration. However, an embodiment is not limited to the specific example. Accordingly, image output may be controlled through other means.

FIG. 18 is a view illustrating controlling of the operation of the barrier unit 110 in the limited segments of the image display timing according to another aspect of an exemplary embodiment.

Referring to FIG. 18, when the first frame is displayed, the operation of the barrier unit 110 is performed in the manner explained above only in the second and third segments. Accordingly, image is actually outputted from these segments, thus ensuring the viewer with the equally-large visual field

In the 3D image display apparatus 100, each electrode may consist of a pair of upper and lower electrodes.

According to an aspect of an exemplary embodiment, the 3D image display apparatus may include the first electrode 111, the second electrode 112 and the third electrode 113, each of which may have a pair of upper and lower electrodes.

That is, the first electrode 111 may include a first upper electrode 111-1 and a first lower electrode 111-2, and the second electrode 112 may include a second upper electrode 112-1 and a second lower electrode 112-2. The third electrode 113 may also include a third upper electrode 113-1 and a third lower electrode 113-2.

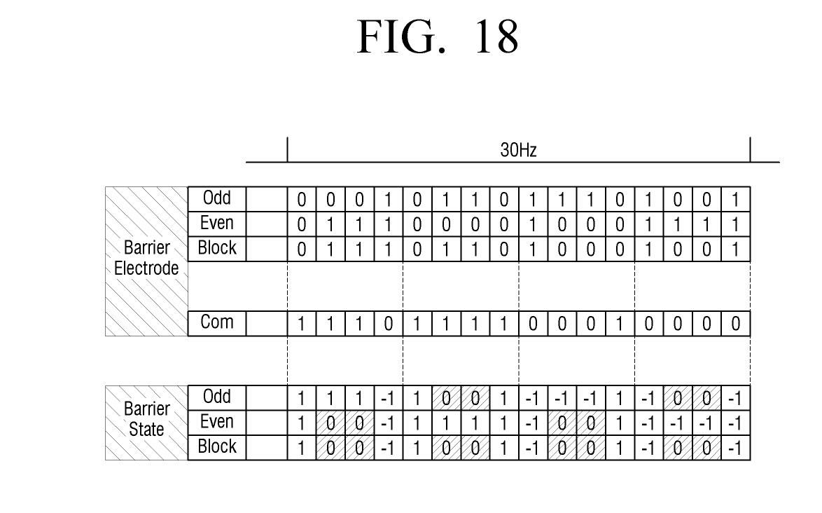

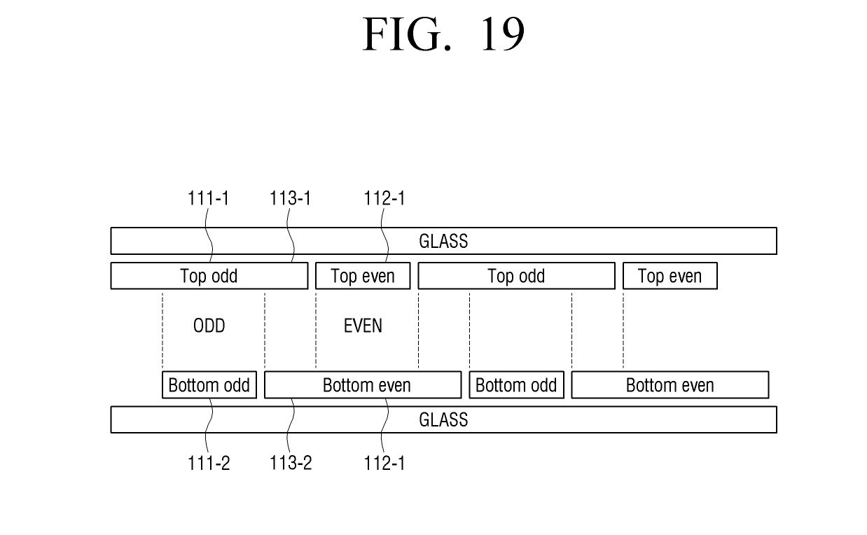

The first upper and lower electrodes 111-1, 111-2 may open or close ODD in the manner as illustrated in FIG. 15, and the second upper and lower electrodes 112-1, 112-2 may open or close EVEN. The third upper and lower electrodes 113-1, 113-2 may open or close BLOCK depending on need. In an exemplary embodiment illustrated in FIGS. 19 to 22, BLOCK may be divided into BLOCK A and BLOCK B. Similar to the exemplary embodiments explained above, the respective electrodes may be implemented in indium tin oxide (ITO) transparent electrodes so that the electrodes themselves do not block the light.

Similar to the exemplary embodiments explained above, a glass substrate 118 may be additionally provided on an outer surface of the upper and lower electrodes and liquid crystal layer (LCC) may be provided between the upper and lower electrodes. The liquid crystal layer (LCC) is explained above.

Meanwhile, the third upper electrode 113-1 may be part of the first upper electrode 111-1 and may operate along with the first upper electrode 111-1.

FIG. 19 illustrates electrode structure when the third electrode 113 operates as part of the first or second electrode 111, 112.

Referring to FIG. 19, the third upper electrode 113-1 may operate together with the first upper electrode 111-1 as part of the first upper electrode 111-1. Further, the third lower electrode 113-2 may operate together with the second lower electrode 112-2 as part of the second lower electrode 112-2. In the above example, the first upper electrode 111-1 and the second lower electrode 112-2 may have an overlapping area with the LCC interposed therebetween.

In the above example, voltage is applied to BLOCK only when the voltage is applied either one of the first upper electrode 111-1 or the second lower electrode 112-2.

FIGS. 20 to 22 are views illustrating controlling of the barrier unit 110 with the above-explained electrode structure including the one illustrated in FIG. 19.

Referring to FIG. 20, similarly to the embodiment of FIG. 16, since the first and second frames are outputted at 120 Hz, respectively, 30 Hz corresponds to the duration that four frames are outputted. Accordingly, the four cells of the table correspond to duration of outputting one image frame. For convenience of explanation, it is assumed that the first, second, third and fourth frames are outputted per four cells in sequence.

When the first frame is displayed with the electrode structure illustrated in FIG. 19, voltage is not applied to the first upper electrode 111-1 and the first lower electrode 111-2, while only the second upper electrode 112-1 applies voltage to EVEN. As a result, EVEN is open and the rest of the areas are closed.

Since the embodiment is similar to the one explained above, displaying the second, third or fourth frame will not be redundantly explained for the sake of brevity.

To summarize the opening of the respective areas of the barrier unit 110 according to an exemplary embodiment, similarly to the exemplary embodiment illustrated in FIG. 16, if one area is open, another area in the same size is closed, and the rest of the areas are closed. Accordingly, the closed area is wider than the open area, and through this, the visual field is expanded.

Referring to FIG. 19, it is also possible to control the electrode signal for a plurality of times (four times in FIG. 19) while one image frame is displayed. Accordingly, it may be possible to control only part of the electrode signal to output image. That is, the opening and closing of the barrier unit 110 may be implemented at a timing of actually displaying 3D image.

For convenience of explanation, it is assumed that the image display apparatus 100 is equipped with a backlight unit (not illustrated). Meanwhile, for emissive device such as OLED, the timing of inputting control signal corresponding to the display operation may be treated as same as the supply timing of the backlight source.

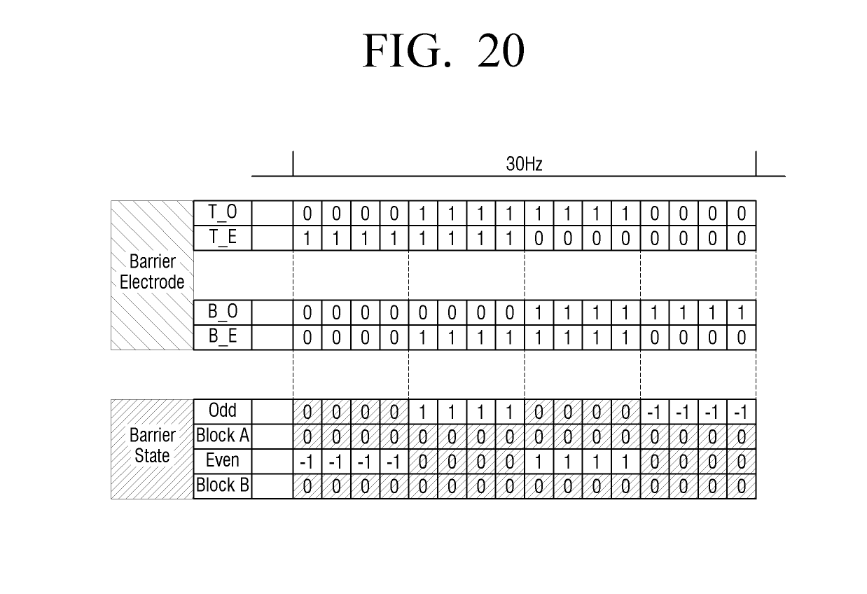

FIG. 21 illustrates controlling of operation of the barrier unit 110 only in limited segments of the image display timing.

Referring to FIG. 21, all the areas are closed for the first segment 1 of the barrier unit 110 in the duration that the first frame is displayed. However, the barrier unit 110 operates in the same manner as explained above with reference to FIG. 20 between segment 2 and segment 4. That is, the backlight is driven only for some of the segments of the duration that the first frame is displayed, with opening EVEN and closing ODD and BLOCK. Since all the areas are closed for the first segment, image is not outputted for this segment, and as a result, the viewer actually views the 3D image same as that of FIG. 16. Controlling the image output through the backlight unit is explained for the purpose of illustration. However, an embodiment is not limited to the specific example. Accordingly, image output may be controlled through other means.

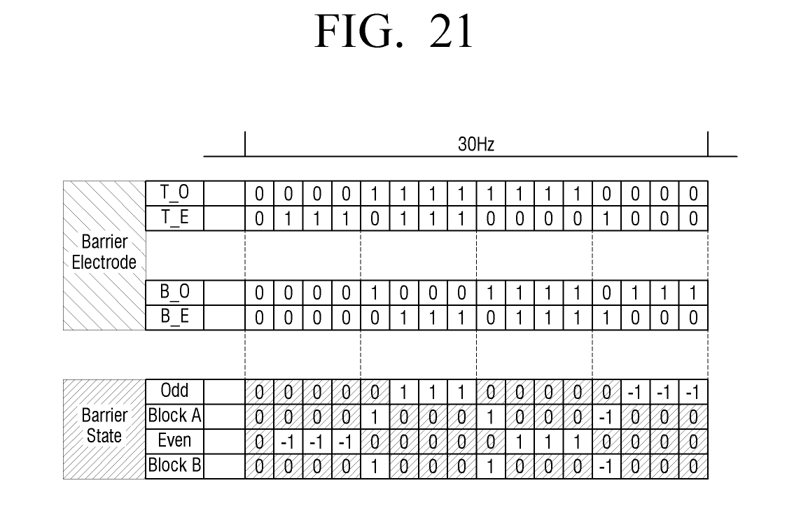

FIG. 22 is a view illustrating controlling of the operation of the barrier unit 110 in the limited segments of the image display timing according to another aspect of an exemplary embodiment.

Referring to FIG. 22, when the first frame is displayed, the operation of the barrier unit 110 is performed in the manner explained above only in the second and third segments. Accordingly, image is actually outputted from these segments, thus ensuring the viewer with an equally-large visual field. Additionally, the area ODD is open and the rest of the areas are closed for the second and third segments in the duration that the second frame is displayed.

Meanwhile, as explained above, resolution of a 3D image is compensated by constructing the image with the first frame in which left-eye and right-eye image pixels are alternately arranged in a horizontal direction, and the second frame in which the left-eye and right-eye image pixels are alternately arranged in a horizontal direction. The control unit may switch the operation of the barrier unit according to the display timing of the first and second frames.

In an exemplary embodiment, the 3D image display apparatus 100 may additionally include a frame processing unit (e.g., frame processor, or circuitry which processes frames) (not illustrated) which constructs the first and second frames by combining a plurality of sub-pixels constituting the left-eye image pixels and a plurality of sub-pixels constituting the right-eye image pixel.

The frame processing unit (not illustrated) may construct the first and second frames by distributing R, G, and B sub-pixels constituting the left-eye image pixel and r, g, and b sub-pixels constituting the right-eye image pixel to the first and second frames and thus combining these into new pixels.

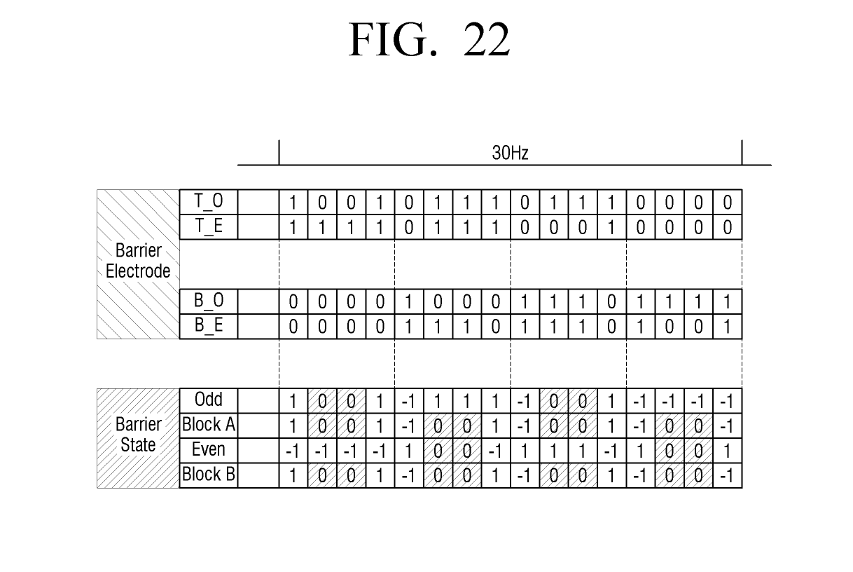

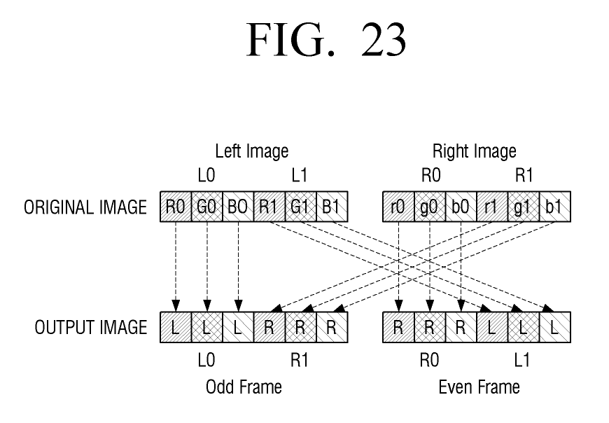

FIG. 23 shows pixel structure when the output image is constructed in the manner explained above. Referring to FIG. 23, the first pixel L0 of the left-eye image of the original image may consist of three sub-pixels R0, G0 and B0. The second pixel L1 may consist of R1, G1, and B1. The first pixel R0 of the right-eye image may consist of r0, g0, b0, and the second pixel R1 may consist of r1, g1, b1. Accordingly, the left-eye and right-eye images are interlaced. As a result, referring to FIG. 23, in the first frame (i.e., output image), the first pixel of the left-eye image is directly arranged as the first pixel, and the second pixel of the right-eye image is arranged as the second pixel. In addition, in the second frame, the first pixel of the right-eye image is arranged as the first pixel, and the second pixel of the left-eye image is arranged as the second pixel.

If the size of the light transmission area is constructed based on interval corresponding to the size of one pixel, r1, g1, b1, r3, g3, b3 of the first frame and r0, g0, b0, r2, g2, b2 of the second frame enter the right eye of the viewer. To the left eye of the viewer, R0, G0, B0, R2, G2, B2 of the first frame, and R1, G1, B1, R3, G3, B3 of the second frame enter. Since the viewer watches both the first and second frames, loss of resolution does not occur.

The frame processing unit (not illustrated) may construct the first and second frames by combining the sub-pixels of the respective pixels of the left-eye and right-eye images in various manners. For example, the frame processing unit (not illustrated) may construct the first frame in the form of R0, g1, B0, r1, G0, b1 and construct the second frame in the form of r0, G0, b0, R1, g1, B1.

A method for displaying 3D image according to an exemplary embodiment will be explained below.

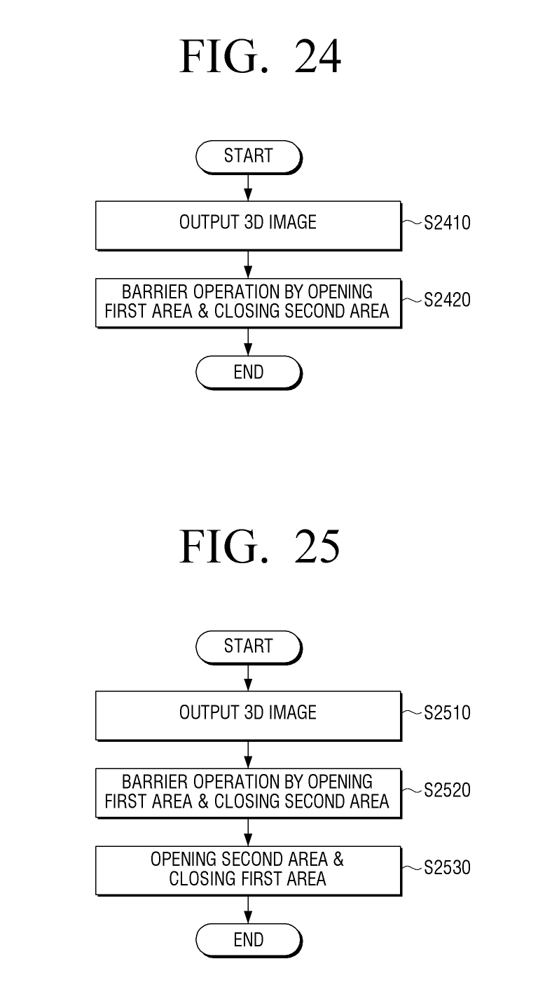

FIGS. 24 to 27 are flowcharts illustrating a method for displaying 3D image according to various embodiments.

Referring to FIG. 24, at S2410, 3D image is outputted, and at S2420, barrier operation is performed in which the first area is open to pass the light in the first direction of the 3D image pixel constituting the 3D image, while the second area is closed to block the light in the second direction of the 3D image pixel. The barrier operation may be implemented so that the first area becomes narrower than the second area.

Referring to FIG. 25, the method for displaying 3D image according to an exemplary embodiment may additionally include outputting 3D image (S2510), performing barrier operation (S2520), and alternately opening and closing the first and second areas (S2530).

The operations at S2510, S2520 are identical to the operations at S2410, S2420.

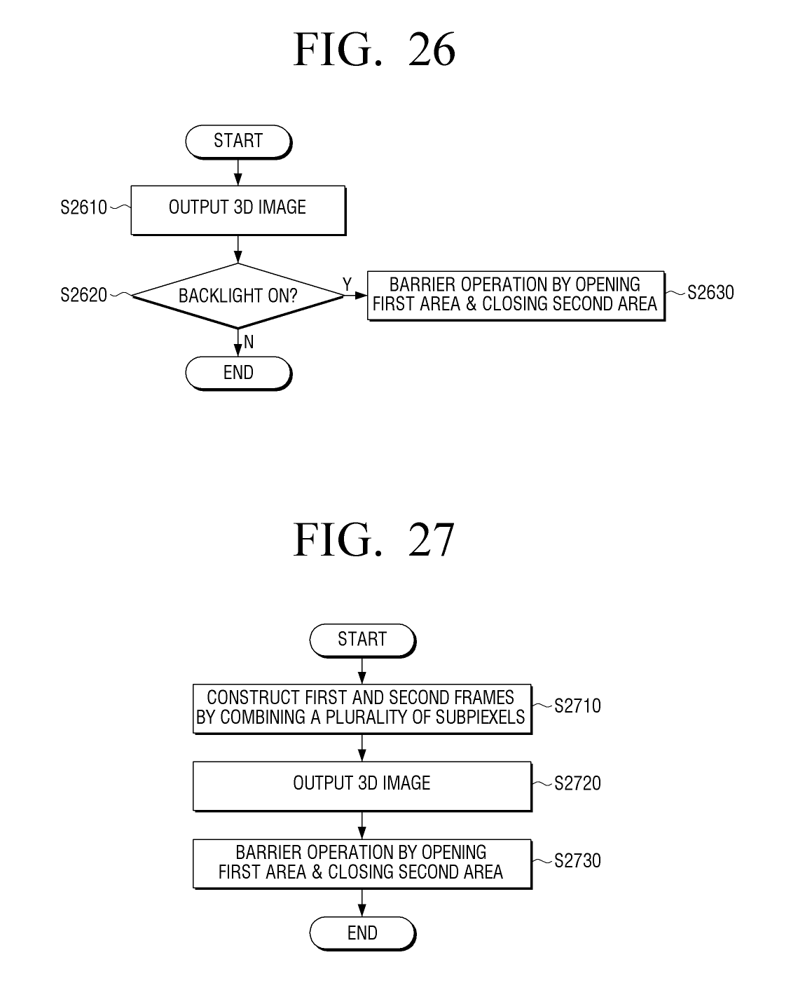

Referring further to FIG. 26, the performing the barrier operation (S2520) of FIG. 24 may include opening the first area and closing the second area (S2630) only when the backlight light source is supplied (S2620-Y), otherwise the barrier unit is not operated (S2620-N).

Further, the method for displaying 3D image may additionally include a step (not illustrated) of alternately opening the first and third areas, and closing the fourth area.

Further, the 3D image may include the first frame in which left-eye and right-eye image pixels are alternately arranged in a horizontal direction, and the second frame in which the left-eye and right-eye image pixels are alternately arranged in a horizontal direction.

Referring further to FIG. 27, the method for displaying 3D image according to an exemplary embodiment may include a frame processing step (S2710) of constructing the first and second frames by combining a plurality of sub-pixels constituting the left-eye image pixel and a plurality of sub-pixels constituting the right-eye image, 3D image outputting step (S2720), and barrier operation step (S2730). The operations at S2720 and S2730 are identical to the operations at S2410 and S2420.

The frame processing step (S2710) may include constructing the first and second frames by distributing R, G, and B sub-pixels constituting the left-eye image pixel and r, g, and b sub-pixels constituting the right-eye image pixel to the first and second frames and thus combining these into new pixels.

The programs for implementing the exemplary embodiments explained above may be recorded in various types of recording media. Specifically, codes to implement the methods explained above may be recorded in various types of terminal-readable recording medium such as RAM (Random Access Memory), flash memory, ROM (Read Only Memory), EPROM (Erasable Programmable ROM), EEPROM (Electronically Erasable and Programmable ROM), register, hard disk, removable disk, memory card, USB memory, or CD-ROM.

The foregoing embodiments and advantages are merely exemplary and are not to be construed as limiting the inventive concept. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

What is claimed is:

1. A three dimensional (3D) image display apparatus, comprising:
a display which outputs a 3D image;
a barrier which opens a first area to pass a light in a first direction of a 3D image pixel, and which closes a second area to block a light in a second direction of the 3D image pixel; and
a controller which controls an operation of the barrier so that the first area becomes narrower than the second area.

2. The 3D image display apparatus of claim 1, wherein the barrier comprises:
a first electrode which applies voltage to the first area; and
a second electrode which applies voltage to an area that is the same size as the first area,
wherein the controller controls the first and second electrodes to operate at alternating times.

3. The 3D image display apparatus of claim 2, wherein the first and second electrodes construct an upper electrode of the barrier, and the barrier additionally comprises a lower electrode which applies default voltage to the first area and the second area.

4. The 3D image display apparatus of claim 1, wherein the barrier comprises:
a first electrode which applies voltage to the first area;
a second electrode which applies voltage to a third area which is part of the second area and which is in the same size as the first area; and
a third electrode which applies voltage to a fourth area which is part of the second area excluding the third area,
wherein the controller controls the first and second electrodes to operate at alternating times in which the third electrode does not apply voltage.

5. The 3D image display apparatus of claim 4, wherein the first, second and third electrodes construct an upper electrode of the barrier, and the barrier additionally comprises a lower electrode which applies default voltage to the first area, the third area, and the fourth area.

6. The 3D image display apparatus of claim 1, further comprising:
a backlight which supplies a light source to the 3D image display apparatus, wherein the controller controls the first area to be open and the second area to be closed only when the light source is supplied through the backlight.

7. The 3D image display apparatus of claim 1, wherein the 3D image comprises a first frame in which left-eye and right-eye image pixels are alternately arranged in a horizontal direction, and a second frame in which the left-eye and right-eye image pixels are alternately arranged in a horizontal direction, and
wherein the controller switches the operation of the barrier at a display timing of the first and second frames.

8. The 3D image display apparatus of claim 7, further comprising:
a frame processor which constructs the first and second frames by combining a plurality of sub-pixels constituting the left-eye image pixel and a plurality of sub-pixels constituting the right-eye image pixel.

9. The 3D image display apparatus of claim 8, wherein the frame processor constructs the first and second frames by selecting sub-pixels from among Red (R), Green (G), Blue (B) sub-pixels constituting the left-eye image pixel and red (r), green (g), blue (b) sub-pixels constituting the right-eye image pixel to be arranged in the first and second frames by combining the selected sub-pixels into new pixels.

10. A method for displaying three dimensional (3D) image, comprising:
outputting a 3D image; and
operating a barrier to open a first area to pass a light in a first direction of a 3D image pixel, and close a second area to block a light in a second direction of the 3D image pixel,
wherein the operating the barrier comprises operating the barrier so that the first area becomes narrower than the second area.

11. The method of claim 10, further comprising:
operating the barrier so that the first and second areas open at alternating times.

12. The method of claim 10, wherein the operating the barrier comprises opening the first area and closing the second area only when a backlight light source is supplied.

13. The method of claim 10, wherein the second area includes a third area that is the same size as the first area, and a fourth area other than the third area, and
wherein the method further comprises operating the barrier so that the first and third areas open at alternating times and closing the fourth area.

14. The method of claim 10, wherein the 3D image comprises a first frame in which left-eye and right-eye image pixels are alternately arranged in a horizontal direction, and a second frame in which the left-eye and right-eye image pixels are alternately arranged in a horizontal direction.

15. The method of claim 14, further comprising:
frame processing which comprises constructing the first and second frames by combining a plurality of sub-pixels constituting the left-eye image pixel and a plurality of sub-pixels constituting the right-eye image pixel.

16. The method of claim 15, wherein the frame processing comprises constructing the first and second frames by selecting sub-pixels from among Red (R), Green (G), Blue (B) sub-pixels constituting the left-eye image pixel and red (r), green (g), blue (b) sub-pixels constituting the right-eye image pixel to be arranged in the first and second frames and by combining the selected sub-pixels into new pixels.

17. A non-transitory computer readable medium comprising computer readable instructions that enable a display apparatus to perform the method of claim 10.

18. A three dimensional (3D) image display apparatus, comprising:
a barrier which opens a first area to pass a light in a first direction of a 3D image pixel, and which closes a second area to block a light in a second direction of the 3D image pixel; and
a controller which controls an operation of the barrier so that the first area becomes narrower than the second area.

19. The 3D image display apparatus of claim 18, wherein the barrier comprises:
a first electrode which applies voltage to the first area;
a second electrode which applies voltage to a third area that is the same size as the first area and which is part of the second area; and
a third electrode which applies voltage to a fourth area which is part of the second area that does not include the third area,
wherein the controller controls the first and second electrodes to operate at alternating times in which the third electrode does not apply voltage.
